(19) United States
(12) Patent Application Publication
(10) Pub. No.: US 2015/0302406 A1
(43) Pub. Date: Oct. 22, 2015

(54) METHODS AND SYSTEMS FOR IMPROVING ACCURANCY OF MERCHANT AGGREGATION

(71) Applicant: MASTERCARD INTERNATIONAL INCORPORATED, Purchase, NY (US)

(72) Inventor: Jeremy Pastore, Brooklyn, NY (US)

(73) Assignee: MASTERCARD INTERNATIONAL INCORPORATED, Purchase, NY (US)

(21) Appl. No.: 14/256,408

(22) Filed: Apr. 18, 2014

(51) Int. Cl. G06Q 20/40

(52) U.S. Cl. CPC G06Q 20/40

(57) ABSTRACT

A method and a system that involve retrieving, from one or more databases, a first set of information including merchant aggregated payment card transaction data, and retrieving, from one or more databases, a second set of information including merchant hierarchical organizational structure. The method and the system further involve analyzing the first set of information and the second set of information to identify one or more associations between the merchant aggregated payment card transaction data and the merchant hierarchical organizational structure, and updating the merchant aggregated payment card transaction data based on the one or more associations. The method and the system provide up-to-date merchant identification information to enable accurate merchant aggregation. The method and the system leverage consumer payment transaction data and up-to-date merchant organizational structure information in a way that enables accurate merchant aggregation.

### BACKGROUND OF THE DISCLOSURE

1. Field of the Disclosure

The present disclosure relates to methods and systems for improving accuracy of merchant aggregation. In particular, the present disclosure relates to leveraging up-to-date merchant organizational structure information in a way to enable more accurate merchant aggregation.

2. Description of the Related Art

When a consumer makes a purchase with a payment card (credit or debit) at a merchant (brick and mortar or online), information about that transaction is stored, including, for example, an identification of the merchant, an amount of the transaction and the time and date of the transaction among other information. That data can be useful for economic and other analyses. In some cases, however, the data identifying a particular merchant is not clean, for example, because individual locations of a merchant may not be properly associated with a parent company. For example, a particular merchant location may be associated with, for example, an individual franchisee instead of a parent company. Another potential problem can arise when a brick and mortar presence of a retailer and an online presence of a retailer have unique merchant identifiers.

The term “merchant aggregation” refers to the process of associating merchant identification data (“ID”) with payment transaction data. Inconsistent, inaccurate or incomplete merchant ID data is routinely routed through a payment network (such as MasterCard) and this can hinder analysis efforts and tie up valuable resources in efforts to validate or correct this identification data.

Merchant aggregation works by assigning clean merchant name and address information to transaction data within a payment network. The merchant-relevant data within a transaction record is cleansed using several business rules and text mining capabilities. Merchant brands can then be aligned with several key categories or classifications. The North American Industry Classification System (NAICS) and the Standard Industrial Classification (SIC) system are the most common approaches for this type of classification and are well-established in prior art and common industry practices; among others.

An important component of merchant aggregation involves having accurate and up-to-date merchant identification information. Without such accurate information, it becomes difficult, if not impossible, to successfully associate payment transaction data with merchant identification data. For example, a payment card company will have access to payment card transaction data associated with a merchant, but without having accurate and up-to-date merchant hierarchical organizational structure information (e.g., information indicating the latest change in ownership of one of a company's subsidiary—when sold to another), it cannot factor this information into merchant aggregation for a particular merchant.

Therefore, a need exists for a method and/or a system that provide up-to-date merchant identification information to enable accurate merchant aggregation. The method and system should include a more holistic database of information including an accurate and up-to-date merchant hierarchical organizational structure (e.g., track ongoing and rapidly moving changes in ownership or restructuring across all merchants). Thus, a method and/or a system are needed that can leverage readily available data feeds up-to-date merchant organizational structure information in a way that enables more accurate merchant aggregation.

### SUMMARY OF THE DISCLOSURE

The present disclosure provides a method that involves retrieving, from one or more databases, a first set of information including merchant aggregated payment card transaction data, and retrieving, from one or more databases, a second set of information including merchant hierarchical organizational structure. The method further includes analyzing the first set of information and the second set of information to identify one or more associations between the merchant aggregated payment card transaction data and the merchant hierarchical organizational structure, and updating the merchant aggregated payment card transaction data based on the one or more associations. The one or more associations include, for example, at least a matching merchant, one or more affiliates of the matching merchant, and/or one or more actions associated with the merchant hierarchical organizational structure.

The present disclosure also provides a method for modifying merchant aggregated payment card transaction data. The method involves receiving first transaction data, the first transaction data comprising a transaction identifier and an associated merchant identifier, the merchant identifier identifying a merchant entity; and mapping the transaction identifier and the merchant identifier to a parent identifier, the parent identifier identifying a parent entity associated with the merchant entity. The method also involves receiving a data feed providing information of a relationship between the parent entity and the merchant entity; and assessing the information to determine whether or not there has been a change in relationship between the parent entity and the merchant entity. In an embodiment, the method further involves receiving information of a change in a relationship between the parent entity and the merchant entity; and remapping the transaction identifier and the merchant identifier to a new parent identifier based on the change in relationship.

The present disclosure further provides a method of maintaining a merchant aggregated payment card transaction data relationship repository. The method involves maintaining a list of merchant identifiers and associated parent identifiers, the merchant identifier identifying a merchant entity and the parent identifier identifying a parent entity associated with the merchant entity; receiving a data feed providing information of a relationship between the parent entity and the merchant entity; and assessing the information to determine whether or not there has been a change in relationship between the parent entity and the merchant entity. In an embodiment, the method also involves receiving a data feed providing an indication of a change in relationship between the parent entity and the merchant entity; and modifying the list of merchant identifiers and associated parent identifiers based on the indication of a change in relationship. In another embodiment, the method further involves receiving a data feed providing an indication of a change in relationship between the parent entity and the merchant entity; and determining for each of the parent entity and the merchant entity whether or not a matching merchant identifier or parent identifier exists within the list of merchant identifiers and associated parent identifiers.

The present disclosure provides a system that includes one or more databases configured to store a first set of information including merchant aggregated payment card transaction data, and one or more databases configured to store a second set of information including merchant hierarchical organizational structure. The system further includes a processor configured to: analyze the first set of information and the second set of information to identify one or more associations between the merchant aggregated payment card transaction data and the merchant hierarchical organizational structure, and update the merchant aggregated payment card transaction data based on the one or more associations. The one or more associations include, for example, at least a matching merchant, one or more affiliates of the matching merchant, and/or one or more actions associated with the merchant hierarchical organizational structure.

The present disclosure also provides a system that includes one or more databases configured to store first transaction data, the first transaction data comprising a transaction identifier and an associated merchant identifier, the merchant identifier identifying a merchant entity; and one or more databases configured to store a data feed providing information of a relationship between the parent entity and the merchant entity. The system also includes a processor configured to: map the transaction identifier and the merchant identifier to a parent identifier, the parent identifier identifying a parent entity associated with the merchant entity; and assess the information to determine whether or not there has been a change in relationship between the parent entity and the merchant entity. In an embodiment, the system includes one or more databases configured to store a data feed providing information of a change in a relationship between the parent entity and the merchant entity; and a processor configured to remap the transaction identifier and the merchant identifier to a new parent identifier based on the change in relationship.

The present disclosure further provides a system that includes one or more databases configured to store a list of merchant identifiers and associated parent identifiers, the merchant identifier identifying a merchant entity and the parent identifier identifying a parent entity associated with the merchant entity; and one or more databases configured to store a data feed providing information of a relationship between the parent entity and the merchant entity. The system also includes a processor configured to assess the information to determine whether or not there has been a change in relationship between the parent entity and the merchant entity. In an embodiment, the system includes one or more databases configured to store a data feed providing information of a change in a relationship between the parent entity and the merchant entity; and a processor configured to modify the list of merchant identifiers and associated parent identifiers based on the indication of a change in relationship. In another embodiment, the system includes one or more databases configured to store a data feed providing information of a change in a relationship between the parent entity and the merchant entity; and a processor configured to determine for each of the parent entity and the merchant entity whether or not a matching merchant identifier or parent identifier exists within the list of merchant identifiers and associated parent identifiers.

The methods and systems of the present disclosure provide up-to-date merchant identification information to enable more accurate merchant aggregation. The methods and systems of the present disclosure include a more holistic database of information including an accurate and up-to-date merchant organizational structure (e.g., a change in ownership or restructuring). The methods and systems of the present disclosure leverage up-to-date merchant organizational structure information in a way that enables more accurate merchant aggregation.

### BRIEF DESCRIPTION OF THE DRAWINGS

FIG. 1 is a diagram of a four party payment card system.

FIG. 2 shows illustrative information types (i.e., merchant aggregated payment card transaction data and the merchant hierarchical organizational structure) used in accordance with the present disclosure.

FIG. 3 illustrates a data warehouse that is a central repository of data which is created by storing certain transaction data from transactions occurring within four party payment card system if FIG. 1.

FIG. 4 is a flow chart representing an automated merchant hierarchy update process in an embodiment of the present disclosure.

FIG. 5 is an example of a merchant hierarchical organizational structure.

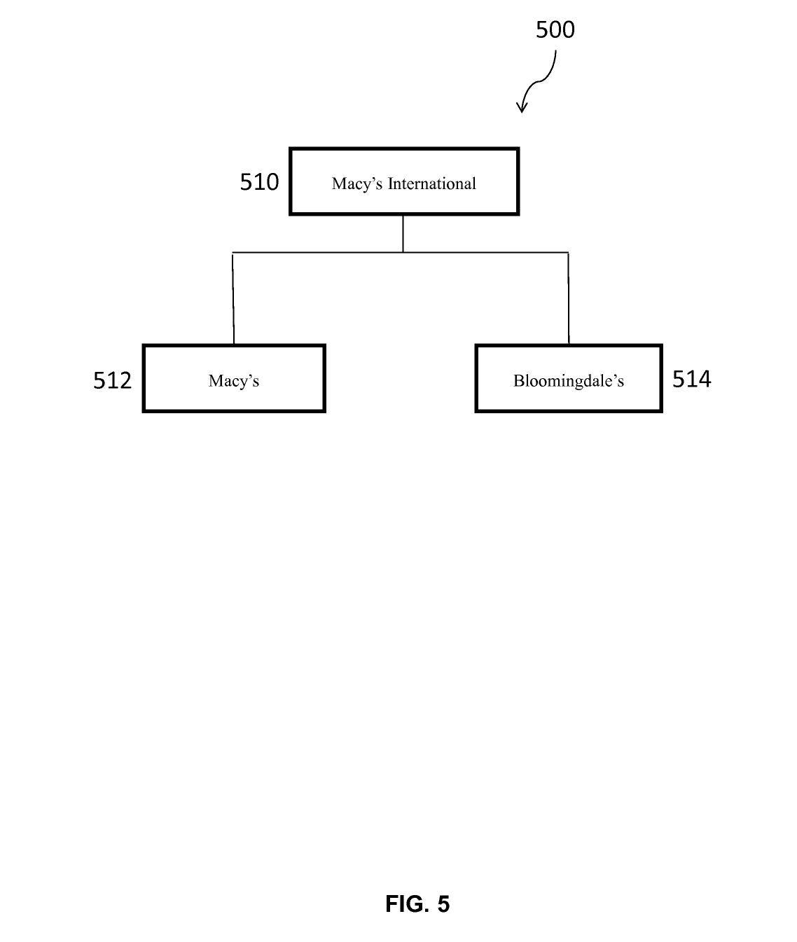

A component or a feature that is common to more than one drawing is indicated with the same reference number in each of the drawings.

### DETAILED DESCRIPTION OF THE PREFERRED EMBODIMENTS

Embodiments of the present disclosure are now described more fully hereinafter with reference to the accompanying drawings, in which some, but not all, embodiments of the disclosure are shown. Indeed, the disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, the one or more databases configured to store the first set of information or from which the first set of information is retrieved, and the one or more databases configured to store the second set of information or from which the second set of information is retrieved, can be the same or different databases.

As used herein, affiliates include any entity that is related to another entity based on their hierarchical organization structure. For example, the relationship can result from mergers, acquisitions, divestitures, spin-offs, and/or bankruptcies involving an entity, e.g., merchant. In particular, affiliates include entities that control, are controlled by, or are under common control, with another entity. In general, entities include parent, subsidiaries, child 1, child 2, and the like, organizations and companies.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions, which execute on the computer or other programmable apparatus, provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to conduct merchant aggregation with up-to-date merchant hierarchical organizational structure information. The systems, methods and computer programs involve analyzing a first set of information including merchant aggregated payment card transaction data and a second set of information including merchant hierarchical organizational structure to identify one or more associations between the merchant aggregated payment card transaction data and the merchant hierarchical organizational structure, and updating the merchant aggregated payment card transaction data based on the one or more associations.

Embodiments of the present disclosure will leverage consumer payment transaction data and up-to-date merchant organizational structure information in a way that enables accurate merchant aggregation. For example, in accordance with this disclosure, a payment card company will have access both to payment card transaction data associated with a merchant, and to accurate and up-to-date merchant organizational structure information (e.g., information indicating a change in ownership or restructuring), that will enable the payment card company to factor this information into merchant aggregation concerning the particular merchant.

In accordance with the present disclosure, a method of and a system are provided for updating hierarchical organizational structure of a business. In particular, the present disclosure provides a method and a system for leveraging consumer payment transaction data and up-to-date merchant organizational structure information in a way that enables more accurate merchant aggregation.

The method of this disclosure generally includes retrieving, from one or more databases, a first set of information including merchant aggregated payment card transaction data, and retrieving, from one or more databases, a second set of information including merchant hierarchical organizational structure. The method further includes analyzing the first set of information and the second set of information to identify one or more associations between the merchant aggregated payment card transaction data and the merchant hierarchical organizational structure, and updating the merchant aggregated payment card transaction data based on the one or more associations. The one or more associations include, for example, at least a matching merchant, one or more affiliates of the matching merchant, and/or one or more actions associated with the merchant hierarchical organizational structure.

The method of this disclosure is also generally directed to modifying merchant aggregated payment card transaction data. The method involves receiving first transaction data, the first transaction data comprising a transaction identifier and an associated merchant identifier, the merchant identifier identifying a merchant entity; and mapping the transaction identifier and the merchant identifier to a parent identifier, the parent identifier identifying a parent entity associated with the merchant entity. The method also involves receiving a data feed providing information of a relationship between the parent entity and the merchant entity; and assessing the information to determine whether or not there has been a change in relationship between the parent entity and the merchant entity.

In an embodiment, this method further involves receiving information of a change in a relationship between the parent entity and the merchant entity; and remapping the transaction identifier and the merchant identifier to a new parent identifier based on the change in relationship.

The method of this disclosure is further generally directed to maintaining a merchant aggregated payment card transaction data relationship repository. The method involves maintaining a list of merchant identifiers and associated parent identifiers, the merchant identifier identifying a merchant entity and the parent identifier identifying a parent entity associated with the merchant entity; receiving a data feed providing information of a relationship between the parent entity and the merchant entity; and assessing the information to determine whether or not there has been a change in relationship between the parent entity and the merchant entity.

In an embodiment, this method also involves receiving a data feed providing an indication of a change in relationship between the parent entity and the merchant entity; and modifying the list of merchant identifiers and associated parent identifiers based on the indication of a change in relationship.

In another embodiment, this method further involves receiving a data feed providing an indication of a change in relationship between the parent entity and the merchant entity; and determining for each of the parent entity and the merchant entity whether or not a matching merchant identifier or parent identifier exists within the list of merchant identifiers and associated parent identifiers.

The system of this disclosure generally includes one or more databases configured to store a first set of information including merchant aggregated payment card transaction data, and one or more databases configured to store a second set of information including merchant hierarchical organizational structure. The system further includes a processor configured to: analyze the first set of information and the second set of information to identify one or more associations between the merchant aggregated payment card transaction data and the merchant hierarchical organizational structure, and update the merchant aggregated payment card transaction data based on the one or more associations. The one or more associations include, for example, at least a matching merchant, one or more affiliates of the matching merchant, and/or one or more actions associated with the merchant hierarchical organizational structure.

The system of this disclosure also generally includes one or more databases configured to store first transaction data, the first transaction data comprising a transaction identifier and an associated merchant identifier, the merchant identifier identifying a merchant entity; and one or more databases configured to store a data feed providing information of a relationship between the parent entity and the merchant entity. The system also includes a processor configured to: map the transaction identifier and the merchant identifier to a parent identifier, the parent identifier identifying a parent entity associated with the merchant entity; and assess the information to determine whether or not there has been a change in relationship between the parent entity and the merchant entity.

In an embodiment, the system includes one or more databases configured to store a data feed providing information of a change in a relationship between the parent entity and the merchant entity; and a processor configured to remap the transaction identifier and the merchant identifier to a new parent identifier based on the change in relationship.

The system of this disclosure further generally includes one or more databases configured to store a list of merchant identifiers and associated parent identifiers, the merchant identifier identifying a merchant entity and the parent identifier identifying a parent entity associated with the merchant entity; and one or more databases configured to store a data feed providing information of a relationship between the parent entity and the merchant entity. The system also includes a processor configured to assess the information to determine whether or not there has been a change in relationship between the parent entity and the merchant entity.

In an embodiment, this system includes one or more databases configured to store a data feed providing information of a change in a relationship between the parent entity and the merchant entity; and a processor configured to modify the list of merchant identifiers and associated parent identifiers based on the indication of a change in relationship.

In another embodiment, this system includes one or more databases configured to store a data feed providing information of a change in a relationship between the parent entity and the merchant entity; and a processor configured to determine for each of the parent entity and the merchant entity whether or not a matching merchant identifier or parent identifier exists within the list of merchant identifiers and associated parent identifiers.

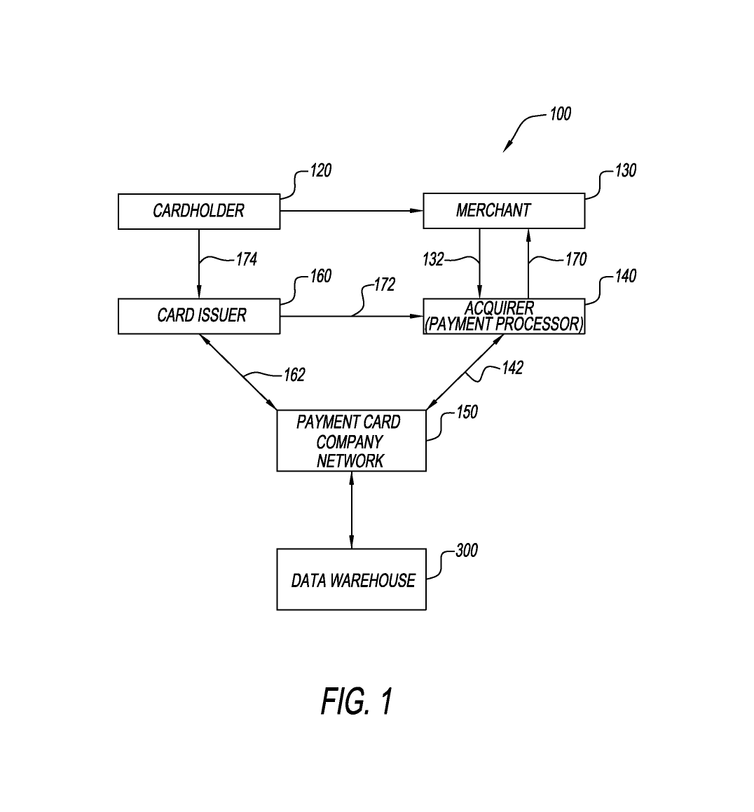

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 300 is a database used by payment card company network 150 for reporting and data analysis. According to one embodiment, data warehouse 300 is a central repository of data which is created by storing certain transaction data from transactions occurring within four party payment card system 100. According to another embodiment, data warehouse 300 stores, for example, the date, time, amount, location, merchant code, and merchant category for every transaction occurring within payment card network 150. In yet another embodiment, data warehouse 300 stores, reviews, and/or analyzes information used in merchant aggregation. In another embodiment, data warehouse 300 aggregates the information by merchant and/or category. In another embodiment, one or more associations between the merchant aggregated payment card transaction data and the merchant hierarchical organizational structure data 304 are identified in data warehouse 300. In still another embodiment, data warehouse 300 integrates data from one or more disparate sources. Data warehouse 300 stores current as well as historical data and is used for creating reports, performing analyses on the network, merchant analyses, and performing predictive analyses.

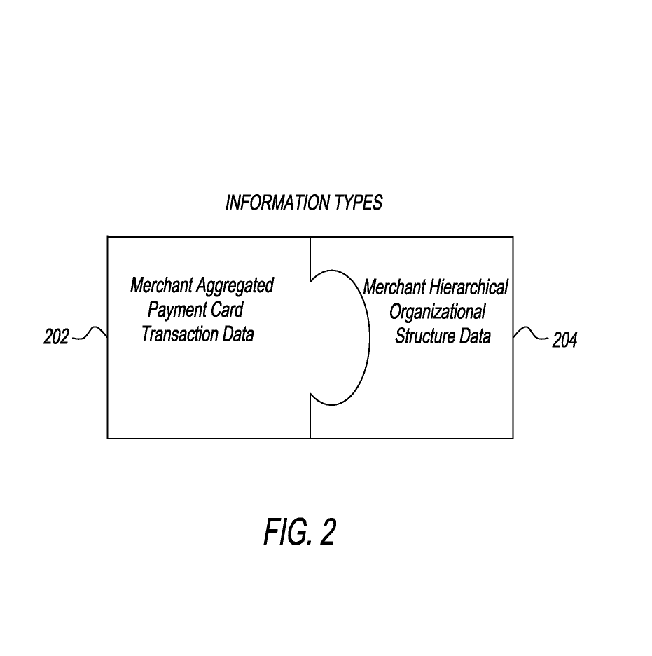

FIG. 2 shows illustrative information types used in the process and system of this disclosure. Illustrative merchant aggregated payment card transaction data 202 includes, for example, payment card transaction data and merchant data that have been aggregated by merchant and/or category. Illustrative merchant hierarchical organizational structure data 204 includes, for example, information about mergers, acquisitions, divestitures, spin-offs, and/or bankruptcies involving one or more merchants.

The payment card transaction data includes information related to payment card transactions, for example, purchasing and payment activities attributable to payment card holders, and merchant identification. Payment card transaction data can be obtained, for example, from payment card companies known as MasterCard®, Visa®, American Express®, and the like (part of the payment card company network 150 in FIG. 1). According to one embodiment, aggregated payment card transaction data 202 includes information related to payment card transactions occurring across a payment card network 150. Aggregated payment card transaction data 202 may include, for example, information related to transactions occurring over the MasterCard payment network over a period of time. According to another embodiment, aggregated payment card transaction data 202 includes, for example, information related to all transactions occurring across the MasterCard, Visa, Discover, or American Express payment networks.

In particular, the payment card transaction information can contain, for example, a merchant identifier, transaction identifier, geolocation of merchant, geolocation of payment card transaction, geolocation date on which payment card transaction occurred, geolocation time on which payment card transaction occurred, and the like.

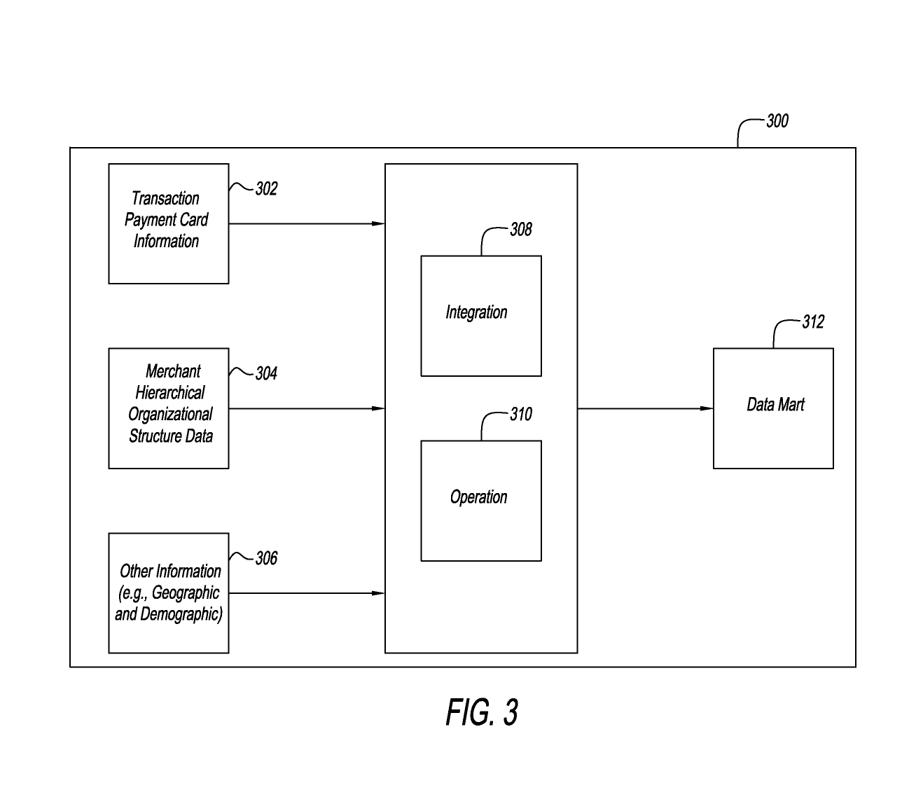

FIG. 3 illustrates an exemplary data warehouse 300 for the storing, reviewing, and/or analyzing of information used for identifying one or more associations between the merchant aggregated payment card transaction data and the merchant hierarchical organizational structure, and updating the merchant aggregated payment card transaction data based on the one or more associations. The data warehouse 300 can contain a plurality of entries (e.g., entries 302, 304, and 306).

The payment card transaction information 302 can contain, for example, purchasing and payment activities attributable to purchasers (e.g., payment card holders), that is aggregated by merchant and/or category in the data warehouse 300. The merchant hierarchical organizational structure information 304 includes, for example, information related to mergers, acquisitions, divestitures, spin-offs, and/or bankruptcies involving the merchant. Other information 306 can include demographic or geographic or other suitable information that may be useful for identifying one or more associations between the merchant aggregated payment card transaction data and the merchant hierarchical organizational structure, and updating the merchant aggregated payment card transaction data based on the one or more associations.

The typical data warehouse uses staging, data integration, and access layers to house its key functions. The staging layer or staging database stores raw data extracted from each of the disparate source data systems. The integration layer integrates at 308 the disparate data sets by transforming the data from the staging layer often storing this transformed data in an operational data store database 310. For example, the payment card transaction information 302 can be aggregated by merchant and/or category at 308. Also, one or more associations between the merchant aggregated payment card transaction data and the merchant hierarchical organizational structure data 304 can be identified at 308. The identified associations can be used to update the merchant aggregated payment card transaction data. The integrated data is then moved to yet another database, often called the data warehouse database or data mart 312, where the data is arranged into groups often called dimensions and into facts and aggregate facts. The access layer helps users retrieve data.

A data warehouse constructed from an integrated data source system does not require staging databases or operational data store databases. The integrated data source systems may be considered to be a part of a distributed operational data store layer. Data federation methods or data virtualization methods may be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 312 can be a small data warehouse focused on a specific area of interest. For example, the data mart 312 can be focused on identification of the one or more associations between the merchant aggregated payment card transaction data and the merchant hierarchical organizational structure data 304. The identified associations can then be used to update the merchant aggregated payment card transaction data. Data warehouses can be subdivided into data marts for improved performance and ease of use within that area. Alternatively, an organization can create one or more data marts as first steps towards a larger and more complex enterprise data warehouse.

Algorithms can be employed to determine formulaic descriptions of the integration of the data source information using any of a variety of known mathematical techniques. These formulas, in turn, can be used to derive or generate one or more analyses and updates for a merchant aggregation activity using any of a variety of available trend analysis algorithms. For example, these formulas can be used to analyze a first set of information including merchant aggregated payment card transaction data and a second set of information including merchant hierarchical organizational structure to identify one or more associations between the merchant aggregated payment card transaction data and the merchant hierarchical organizational structure, and update the merchant aggregated payment card transaction data based on the one or more associations.

Other information 306 can also include, for example, data sources that can be leveraged to improve the accuracy of merchant aggregation. Illustrative other information 306 can include, for example, demographic, geographic (e.g., merchant zip code), and the like. More specifically, other illustrative information 306 can include, for example, information concerning merchant background, merchant history, merchant special events, merchant operation, merchant payments, merchant payment trends, merchant financial statement, merchant public filings, and risk (e.g., information related to payment card holder dynamics, satisfaction and concerns with a merchant). These data sources can supplement the merchant hierarchical organization structure information and help to enable more accurate merchant aggregation. According to various embodiments, the various data sources can include, for example, the following:
Merchant background information can include, for example, ownership, history and principals of the merchant, and the operations and location of the merchant.
Merchant history information can include, for example, incorporation details, par value of shares and ownership information, background information on management, such as educational and career history and company principals, related companies including identification of affiliates including, but not limited to, parent, subsidiaries and/or branches worldwide. The merchant history information can also include corporate registration details to verify the existence of a registered organization, confirm legal information such as a merchant's organizational structure, date and state of incorporation, and research possible fraud by reviewing names of principals and business standing within a state.
Merchant special event information can include, for example, any developments that may impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).
Merchant operational information can include, for example, the identity of the parent company, the number of accounts and geographic scope of the business, typical selling terms, and whether the merchant owns or leases its facilities. The names and locations of branch operations and subsidiaries can also be identified.
Merchant payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.
Merchant payment trend information can include, for example, information that spots trends in a merchant's business by analyzing how it pays its bills.
Merchant financial statement information can include, for example, a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss account provide information on the operation of the enterprise. These include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.
Merchant public filing information can include, for example, bankruptcy filings, suits, liens, and judgment information obtained from Federal and State court houses for a company.
The risk data source includes information related to open lines of credit, utilization and risk score. In particular, information for inclusion in the risk data source relates to information concerning credit services, marketing services, decision analytics and consumer services. The risk data source can also include information on people, businesses, motor vehicles and insurance. The risk data source can also include ‘lifestyle’ data from on-line and off-line surveys.

While up-to-date merchant identification information is of primary concern for enabling accurate merchant aggregation, the additional information described above can also be useful in more fully understanding the merchant identification information or contributing to the overall merchant aggregation activity.

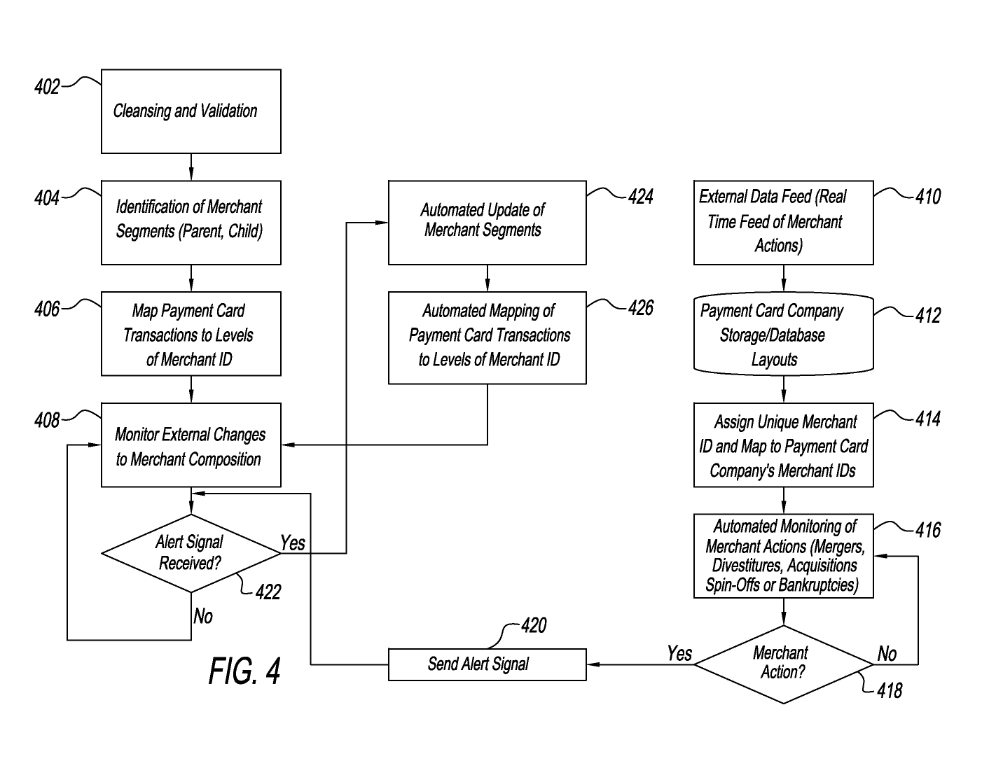

FIG. 4 illustrates a process of the present disclosure that is conducted, for example, by a payment card company (part of the payment card company network 150 in FIG. 1). Cleansing and validation of payment card transactions occurs at 402. At 404, identification of the merchant hierarchical organizational structure occurs, for example, identification of merchant segments including parent, first child, second child, and the like. For example and referring now to FIG. 4, in the Macy's organization 500, Macy's international holding company is identified as the parent 510, Macy's as a first child 512, and Bloomingdale's as a second child 514.

The payment card transactions are then mapped at 406 to the lowest (child) level identified for the merchant hierarchical organizational structure. The merchant hierarchical organizational structure is then monitored at 408 for any external changes that may directly or indirectly affect the structure.

In accordance with this disclosure, an external data feed including a real time feed of merchant actions, is obtained by the payment card company at 410. The data from the external feed is entered into storage at the payment card company and organized into database layouts at 412. At 414, a unique merchant identification is assigned to the external data that is then mapped to the payment card company's merchant identifications. At 416, automated monitoring of merchant hierarchical organizational structure actions occurs, for example, mergers, acquisitions, divestitures, spin-offs, and/or bankruptcies involving the merchant. The automated monitoring can include, for example, data feeds from publicly available sources which can be fee based or non-fee based services.

If no merchant hierarchical organizational structure actions are identified at 418, then no further action occurs and the monitoring of the external data continues. However, if merchant hierarchical organizational structure actions are identified at 418, then an alert signal is sent at 420 and received at 422. The monitoring at 408 for any external changes that can directly or indirectly affect the merchant hierarchical organizational structure assesses the alert and the action.

If no changes need to be made to the merchant hierarchical organizational structure based on the actions identified at 418, then no further action occurs and the monitoring of the external data continues. However, if changes need to be made to the merchant hierarchical organizational structure based on the actions identified at 418, then an automated update of the merchant hierarchical organizational structure occurs at 424. At 426, automated mapping of the payment card transactions to each level identified for the merchant hierarchical organizational structure (e.g., parent/child mapping) occurs.

It will be understood that the present disclosure can be embodied in a computer readable non-transitory storage medium storing instructions of a computer program which when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the present system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving, from one or more databases, a first set of information including merchant aggregated payment card transaction data;
retrieving, from one or more databases, a second set of information including merchant hierarchical organizational structure;
analyzing the first set of information and the second set of information to identify one or more associations between the merchant aggregated payment card transaction data and the merchant hierarchical organizational structure; and
updating the merchant aggregated payment card transaction data based on the one or more associations.

2. The method of claim 1, wherein the one or more associations comprise at least a matching merchant, one or more affiliates of the matching merchant, and/or one or more actions associated with the merchant hierarchical organizational structure.

3. The method of claim 1, wherein the first set of information includes one or more of the following: payment card transaction data and merchant data, and optionally geographic and/or demographic information; and the second set of information includes information concerning one or more of the following: mergers, acquisitions, divestitures, spin-offs, and bankruptcies involving the merchant.

4. The method of claim 1, wherein the first set of information includes one or more of the following: a merchant identifier, transaction identifier, geolocation of merchant, geolocation of payment card transaction, geolocation date on which payment card transaction occurred, and geolocation time on which payment card transaction occurred.

5. The method of claim 1, further comprising aggregating the updated merchant aggregated payment card transaction data.

6. A method for modifying merchant aggregated payment card transaction data comprising:
receiving first transaction data, the first transaction data comprising a transaction identifier and an associated merchant identifier, the merchant identifier identifying a merchant entity;
mapping the transaction identifier and the merchant identifier to a parent identifier, the parent identifier identifying a parent entity associated with the merchant entity;
receiving a data feed providing information of a relationship between the parent entity and the merchant entity; and
assessing the information to determine whether or not there has been a change in relationship between the parent entity and the merchant entity.

7. The method of claim 6, further comprising:
receiving information of a change in a relationship between the parent entity and the merchant entity; and
remapping the transaction identifier and the merchant identifier to a new parent identifier based on the change in relationship.

8. The method of claim 6, wherein the first transaction data includes one or more of the following: payment card transaction data and merchant data, and optionally geographic and/or demographic information; and the data feed includes information concerning one or more of the following: mergers, acquisitions, divestitures, spin-offs, and bankruptcies involving the merchant.

9. The method of claim 6, wherein the data feed is a real time feed of information including at least information relating to a relationship between the parent entity and the merchant entity.

10. The method of claim 6, wherein the method is carried out by a financial transaction processing entity.

11. A method of maintaining a merchant aggregated payment card transaction data relationship repository comprising:
maintaining a list of merchant identifiers and associated parent identifiers, the merchant identifier identifying a merchant entity and the parent identifier identifying a parent entity associated with the merchant entity;
receiving a data feed providing information of a relationship between the parent entity and the merchant entity; and
assessing the information to determine whether or not there has been a change in relationship between the parent entity and the merchant entity.

12. The method of claim 11 further comprising:
receiving a data feed providing an indication of a change in relationship between the parent entity and the merchant entity; and
modifying the list of merchant identifiers and associated parent identifiers based on the indication of a change in relationship.

13. The method of claim 11 further comprising:
receiving a data feed providing an indication of a change in relationship between the parent entity and the merchant entity; and
determining for each of the parent entity and the merchant entity whether or not a matching merchant identifier or parent identifier exists within the list of merchant identifiers and associated parent identifiers.

14. A system comprising:
one or more databases configured to store a first set of information including merchant aggregated payment card transaction data;
one or more databases configured to store a second set of information including merchant hierarchical organizational structure;
a processor configured to:
analyze the first set of information and the second set of information to identify one or more associations between the merchant aggregated payment card transaction data and the merchant hierarchical organizational structure; and
update the merchant aggregated payment card transaction data based on the one or more associations.

15. The system of claim 14, wherein the one or more associations comprise at least one of the following: a matching merchant, one or more affiliates of the matching merchant, and one or more actions associated with the merchant hierarchical organizational structure.

16. The system of claim 14, wherein the first set of information includes one or more of the following: payment card transaction data and merchant data, and optionally geographic and/or demographic information; and the second set of information includes information concerning one or more of the following: mergers, acquisitions, divestitures, spin-offs, and bankruptcies involving the merchant.

17. The system of claim 14, wherein the first set of information includes one or more of the following: a merchant identifier, transaction identifier, geolocation of merchant, geolocation of payment card transaction, geolocation date on which payment card transaction occurred, and geolocation time on which payment card transaction occurred.

18. The system of claim 14, wherein the processor is further configured to:
aggregate the updated merchant aggregated payment card transaction data.

19. A system comprising:
one or more databases configured to store first transaction data, the first transaction data comprising a transaction identifier and an associated merchant identifier, the merchant identifier identifying a merchant entity;
one or more databases configured to store a data feed providing information of a relationship between the parent entity and the merchant entity;
a processor configured to:
map the transaction identifier and the merchant identifier to a parent identifier, the parent identifier identifying a parent entity associated with the merchant entity; and
assess the information to determine whether or not there has been a change in relationship between the parent entity and the merchant entity.

20. The system of claim 19, further comprising:
one or more databases configured to store a data feed providing information of a change in a relationship between the parent entity and the merchant entity; and
a processor configured to:
remap the transaction identifier and the merchant identifier to a new parent identifier based on the change in relationship.

21. The system of claim 19, wherein the first transaction data includes one or more of the following: payment card transaction data and merchant data, geographic and/or demographic information; and the data feed includes information concerning one or more of the following: mergers, acquisitions, divestitures, spin-offs, and bankruptcies involving the merchant.

22. The system of claim 19, wherein the data feed is a real time feed of information including at least information relating to a relationship between the parent entity and the merchant entity.

23. The system of claim 19, which is carried out by a financial transaction processing entity.

24. A system comprising:
one or more databases configured to store a list of merchant identifiers and associated parent identifiers, the merchant identifier identifying a merchant entity and the parent identifier identifying a parent entity associated with the merchant entity;
one or more databases configured to store a data feed providing information of a relationship between the parent entity and the merchant entity;
a processor configured to:
assess the information to determine whether or not there has been a change in relationship between the parent entity and the merchant entity.

25. The system of claim 24, further comprising:
one or more databases configured to store a data feed providing information of a change in a relationship between the parent entity and the merchant entity; and
a processor configured to:
modify the list of merchant identifiers and associated parent identifiers based on the indication of a change in relationship.

26. The system of claim 24, further comprising:
one or more databases configured to store a data feed providing information of a change in a relationship between the parent entity and the merchant entity; and
a processor configured to:
determine for each of the parent entity and the merchant entity whether or not a matching merchant identifier or parent identifier exists within the list of merchant identifiers and associated parent identifiers.
